(19) United States
(12) Patent Application Publication
(10) Pub. No.: US 2008/0062566 A1
(43) Pub. Date: Mar. 13, 2008

(54) Magnetic head slider with crown profile and fabrication method for the magnetic head slider

(75) Inventors: Hironori Namba, Niigata-ken (JP); Hirohisa Ishihara, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/888,841

(22) Filed: Aug. 2, 2007

(30) Foreign Application Priority Data
Sep. 8, 2006 (JP) 2006-243637

(51) Int. Cl. G11B 5/60

(52) U.S. Cl. 360/234.6

(57) ABSTRACT

A magnetic head slider and a fabrication method for the magnetic head slider are provided in which a change in crown profile shapes resulting from a temperature difference is suppressed. The magnetic head slider includes a read/write element integrated on a slider body. A medium-facing surface of the slider body disposed to face a recording medium is subjected to crown processing. Both longitudinal ends of a slider-bottom surface disposed opposite the medium-facing surface are bonded to a suspension by means of resin adhesive. In this case, the slider-bottom surface is entirely coated with a film having a thermal expansion coefficient smaller than that of the slider body so as to suppress thermal deformation.

### RELATED APPLICATIONS

This application claims the benefit of priority under 35 U.S.C. § 119 to Japanese Patent Application No. 2006-243637 filed Sep. 8, 2006, which is hereby incorporated by reference in its entirety.

### BACKGROUND

1. Technical Field

The present disclosure relates to a magnetic head slider with a crown profile and a fabrication method for the magnetic head slider.

2. Description of the Related Art

Flying-type magnetic head sliders used in hard disk drives (HDDs) perform read/write operations while floating over a recording medium at a predetermined height. The slider includes a suspension made of flexible thin metal plate, a slider body supported by the suspension, and a thin-film read/write element formed on one end face of the slider body. A slider-bottom surface that is disposed opposite a medium-facing surface of the slider body disposed to face a recording medium is bonded to the suspension by means of resin adhesive. The resin adhesive that bonds the slider-bottom surface to the suspension is partially applied onto both longitudinal ends of the slider-bottom surface of the slider body.

The medium-facing surface is usually subjected to a crown processing in order to reduce frictional or suctional forces between the recording medium and the slider body sliding over the medium. In many cases, such a crown processing is performed by means of an air-bearing-surface (ABS) processing performed onto the medium-facing surface of the slider body, or of a polishing processing performed onto the slider-bottom surface. JP-A-8-106749 discloses a technology for providing a crown profile to a medium-facing surface of a slider body. According to the technology, a thin film having a thermal expansion coefficient different from that of the slider body is formed on a slider-bottom surface (flat surface) at a temperature higher than an operating temperature of the slider. Accordingly, the medium-facing surface can have a crown profile thanks to difference in the thermal expansion coefficient between the thin film and the slider body.

In magnetic head sliders having such a crown profile, as the crown profile shape changes with temperature, the floating height over the surface of the recording medium becomes unstable.

### SUMMARY

It is an object of the disclosure to provide a magnetic head slider and a fabrication method for the magnetic head slider capable of suppressing a change in crown profile shapes resulting from a temperature difference.

The disclosure has been made based on findings that the change in crown profile shapes resulting from a temperature difference is caused by the thermal deformation of resin adhesive disposed between the slider-bottom surface and the suspension. When ambient temperature increases, both longitudinal ends of the slider body that are in contact with the resin adhesive expands more than the central portion of the slider body by thermal expansion of the resin adhesive. As a result, the crown profile decreases compared to that before increasing the temperature and thus the floating height of the slider becomes smaller. When ambient temperature decreases, both longitudinal ends of the slider body that are in contact with the resin adhesive shrink more than the central portion of the slider body by thermal shrinking of the resin adhesive. As a result, the crown profile increases compared to that before decreasing the temperature and thus the floating height of the slider becomes greater.

It is best if the crown profile and the slider floating height remain constant over a wide temperature range. In this respect, the disclosure proposes a technology for suppressing the change in the crown profile shapes resulting from a temperature difference. The technology adopts a film for suppressing thermal deformation. The film is operable to deform the slider body in the direction for protruding the central portion when both longitudinal ends of the slider body expand more than the central portion by thermal expansion of the resin adhesive. The film is also operable to deform the slider body in the direction for depressing the central portion when both longitudinal ends of the slider body expand more than the central portion by thermal expansion of the resin adhesive.

In a first aspect of the disclosure, a magnetic head slider includes a read/write element integrated on a slider body. A medium-facing surface of the slider body disposed to face a recording medium is subjected to a crown processing. Both longitudinal ends of a slider-bottom surface disposed opposite the medium-facing surface are bonded to a suspension by means of resin adhesive. In this case, the slider-bottom surface is entirely coated with a film having a thermal expansion coefficient smaller than that of the slider body so as to suppress thermal deformation. The film for suppressing thermal deformation is less likely to deform than the slider body due to difference in their thermal expansion coefficients. When the temperature increases, the thermal expansion suppressing film is operable to suppress the slider body from expanding and to deform the slider body in the direction for protruding the central portion in the longitudinal direction, thereby balancing out deformation of both longitudinal ends resulting from the thermal expansion of the resin adhesive. When the temperature decreases, the thermal expansion suppressing film is operable to suppress the slider body from shrinking and to deform the slider body in the direction for depressing the central portion in the longitudinal direction, thereby balancing out deformation of both longitudinal ends resulting from the thermal shrinking of the resin adhesive. Accordingly, the change in the crown profile shapes resulting from the temperature difference can be suppressed by the thermal deformation suppressing film.

The thermal expansion coefficient of the thermal expansion suppressing film is more than 10 times smaller than that of the slider body for best results. The greater the difference in the thermal expansion coefficient between the thermal expansion suppressing film and the slider body, the smaller the thickness of the thermal expansion suppressing film required to balance out the deformation of both longitudinal ends of the slider body resulting from the thermal deformation of the resin adhesive. The slider body may be made of AlTiC, and the thermal expansion suppressing film may be made of SiO₂.

In a second aspect of the disclosure, a fabrication method for a magnetic head slider includes the steps of: preparing a plurality of thin-film read/write elements on a substrate and cutting the substrate for each read/write element to obtain a plurality of slider bodies; performing a crown processing on medium-facing surfaces of the slider bodies; coating surfaces disposed opposite the medium-facing surfaces with a film made of a material having a thermal expansion coefficient smaller than that of each slider body to suppress thermal deformation, the coating being individually performed to the crown-processed slider bodies; and bonding both longitudinal ends of each of the slider bodies to a suspension by means of resin adhesive with the thermal expansion suppressing film disposed to face the suspension.

In the second aspect, the thermal expansion suppressing film is made of a material having a thermal expansion coefficient more than 10 times smaller than that of the slider body for best results. For example, when the substrate serving as the slider bodies is an AlTiC substrate, the thermal expansion suppressing film may be made of SiO₂.

In the second aspect, the fabrication method may include, after performing a crown processing on the slider bodies, measuring a thermal deformation amount of the longitudinal ends of each of the slider bodies while varying ambient temperature of the magnetic head slider. In this case, a thickness of the thermal expansion suppressing film may be adjusted based on the measurement result so that the thermal deformation amount of the longitudinal ends is balanced out by the adjusted film thickness. Accordingly, the change in the crown profile shapes resulting from the temperature difference can be suppressed with high precision.

According to the aspects of the disclosure, the slider-bottom surface is coated with the thermal expansion suppressing film. The film is operable to deform the slider body in the direction for protruding the central portion when both longitudinal ends of the slider body expand more than the central portion by thermal expansion of the resin adhesive. The film is also operable to deform the slider body in the direction for depressing the central portion when both longitudinal ends of the slider body expand more than the central portion by thermal expansion of the resin adhesive. Thus, the amount of thermal deformation of the longitudinal ends of the slider body resulting from the thermal deformation of the resin adhesive can be balanced out by the thermal expansion suppressing film. Accordingly, a magnetic head slider and a fabrication method for the magnetic head slider can be realized in which the change in the crown profile shapes resulting from the temperature difference is suppressed.

### BRIEF DESCRIPTION OF THE DRAWINGS

The components in the figures are not necessarily to scale, emphasis instead being placed upon illustrating the principles of the disclosure. Moreover, in the figures, like referenced numerals designate corresponding parts throughout the different views.

FIG. 1 is a sectional view showing a schematic construction of a magnetic head slider according to an embodiment of the disclosure.

FIG. 2 is a sectional view showing a change in profile shapes of a medium-facing surface of the magnetic head slider observed at increased operating ambient temperature, wherein (a) and (b) show profiles observed before and after increasing the ambient temperature, and (c) shows a profile observed after increasing the ambient temperature when the medium-facing surface does not have a thermal deformation suppressing film.

FIG. 3 is a sectional view showing a change in profile shapes of a medium-facing surface of the magnetic head slider observed at decreased ambient temperature, wherein (a) and (b) show profiles observed before and after decreasing the ambient temperature, and (c) shows a profile observed after decreasing the ambient temperature when the medium-facing surface does not have a thermal deformation suppressing film.

FIG. 4 is a graph showing a change in profile shapes of a medium-facing surface of a pico slider observed at increased ambient temperature (from 25° C. to 70° C.), the change shown for each thickness of the thermal deformation suppressing film used.

FIG. 5 is a graph of a relationship between an amount of the change in crown profile shapes and the thickness of the thermal deformation suppressing film used, the relationship observed at increased ambient temperature (from 25° C. to 70° C.) of the pico slider.

FIG. 6 is a graph showing a change in profile shapes of a medium-facing surface of the pico slider observed at decreased ambient temperature (from 25° C. to 0° C.), the change shown for each thickness of the thermal deformation suppressing film used.

FIG. 7 is a graph of a relationship between an amount of the change in crown profile shapes and the thickness of the thermal deformation suppressing film used, the relationship observed at decreased ambient temperature (from 25° C. to 0° C.) of the pico slider.

FIG. 8 is a graph showing a change in profile shapes of a medium-facing surface of a femto slider observed at increased ambient temperature (from 25° C. to 70° C.), the change shown for each thickness of the thermal deformation suppressing film used.

FIG. 9 is a graph of a relationship between an amount of the change in crown profile shapes and the thickness of the thermal deformation suppressing film used, the relationship observed at increased ambient temperature (from 25° C. to 70° C.) of the femto slider.

FIG. 10 is a graph showing a change in profile shapes of a medium-facing surface of the femto slider observed at decreased ambient temperature (from 25° C. to 0° C.), the change shown for each thickness of the thermal deformation suppressing film used.

FIG. 11 is a graph of a relationship between an amount of the change in crown profile shapes and the thickness of the thermal deformation suppressing film used, the relationship observed at decreased ambient temperature (from 25° C. to 0° C.) of the femto slider.

### DESCRIPTION OF THE EXEMPLARY EMBODIMENTS

Exemplary embodiments may be better understood with reference to the drawings, but these examples are not intended to be of a limiting nature. Like numbered elements in the same or different drawings perform equivalent or corresponding functions.

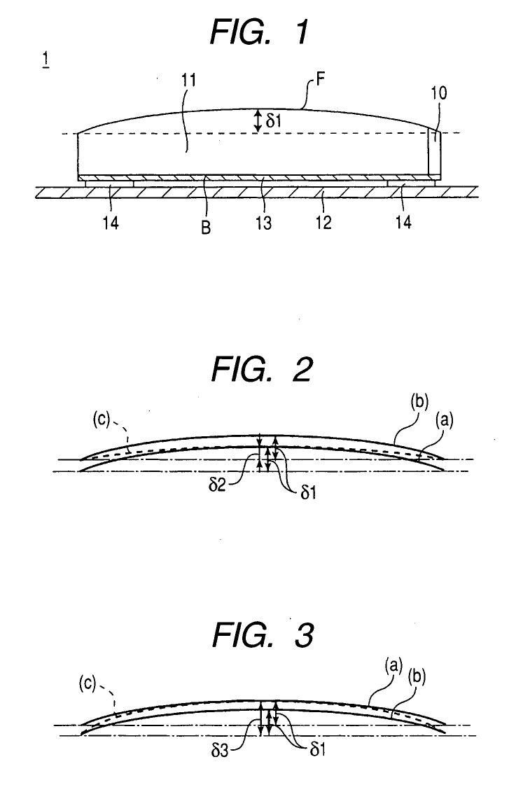

FIG. 1 is a sectional view showing a schematic construction of a magnetic head slider according to an embodiment of the disclosure. The magnetic head slider 1 is a floating-type slider that performs read/write operations while floating over a recording medium at a predetermined height by means of the air flow generated from the surface of the medium. The slider 1 includes a slider body 11 with a read/write element 10 integrated thereon.

The slider body 11 is formed in a rectangular parallelepiped shape and is made of ceramic materials (for example, AlTiC). A slider-bottom surface B opposite a medium-facing surface F disposed to face the recording medium is bonded to a suspension 12 by means of resin adhesive 14. Examples of the slider body 11 applicable to the disclosure include a pico slider (length: 1.25 mm, width: 1.00 mm, thickness, 0.30 mm, mass: 1.5 g) and a femto slider (length: 0.85 mm, width: 0.70 mm, thickness, 0.23 mm, mass: 0.5 g). The suspension 12 is formed of a flexible thin metal plate, generally a stainless thin plate. The resin adhesive 14 is made of resin materials mainly containing urethane acrylate resins, and has a thermal expansion coefficient of about 400×10⁻⁶ [K⁻¹]. The resin adhesive 14 is partially applied onto both longitudinal ends of the slider-bottom surface B.

The medium-facing surface F of the magnetic head slider 1 (including the read/write element 10 and the slider body 11) is formed in an elliptical-parabolic shape by means of a polishing processing, for example, such that the central portion is protruded orthogonal to the longitudinal direction a greater distance toward the recording medium than the protrusion of its longitudinal ends. Note that the longitudinal direction is defined along the length of the slider 11. A crown profile having a height 51 (the maximum height of the elliptical-parabolic shape) is provided to the central portion in a direction orthogonal to the longitudinal direction. A magneto-resistive element and an inductive element of the read/write element 10 are exposed to the medium-facing surface F. A protective film of the read/write element 10 is exposed to the slider-bottom surface B. Although not shown in the drawings, a slider rail for generating an air-bearing force is formed in the slider-bottom surface B.

The slider-bottom surface B (including the slider rail and the protective film of the read/write element 10) may be entirely coated with a thermal deformation suppressing film 13 made of materials having a thermal expansion coefficient smaller than that of the slider body 11. In this embodiment, the thermal expansion suppressing film 13 is made of SiO₂.

The thermal deformation suppressing film 13 has a function of deforming the medium-facing surface F in a convex or concave shape by taking advantage of the difference in the thermal expansion coefficient between the thermal expansion suppressing film 13 and the slider body 11, thereby suppressing the change in crown profile shapes resulting from a difference in the ambient temperature of the magnetic head slider 1. Although the thickness is exaggerated in FIG. 1, the thickness of the thermal expansion suppressing film 13 is actually in the range of 1 to 5 μm.

FIGS. 2 and 3 are sectional views showing a change in profile shapes of the medium-facing surface observed at different operating ambient temperatures of the magnetic head slider 1. FIG. 2 is for the case where ambient temperature of the magnetic head slider 1 is increased, and FIG. 3 is for the case where ambient temperature of the magnetic head slider 1 is decreased. In FIGS. 2 and 3, (a) and (b) show profiles observed before and after increasing the ambient temperature, respectively, and (c) shows a profile observed after increasing the ambient temperature when the medium-facing surface does not have the thermal deformation suppressing film 13.

When ambient temperature of the magnetic head slider 1 increases, the slider body 11 (including the protective film of the read/write element 10), the thermal expansion suppressing film 13, and the resin adhesive 14 are deformed in the same expanding direction. In this case, since both longitudinal ends of the slider body 11 are in contact with the resin adhesive 14, the longitudinal ends expand more than the central portion in the longitudinal direction by the thermal expansion of the resin adhesive 14. Since the thermal expansion coefficient of the thermal expansion suppressing film 13 is smaller than that of the slider body 11, the thermal expansion suppressing film 13 is operable to suppress the expansion of the slider body 11 resulting from the increased temperature. The medium-facing surface F is deformed in a direction that causes the central portion of the slider body 11 to protrude orthogonal to the longitudinal direction further out, e.g. toward the recording medium 11, by the difference in the thermal expansion coefficient of the thermal expansion suppressing film 13 and the slider body 11 (see the curve (a) in FIG. 2). Accordingly, the height of the central portion orthogonal to the longitudinal direction of the slider body 11 increases and thus balances out (cancels) the increased height of both longitudinal ends resulting from the thermal expansion of the resin adhesive 14. As a result, it is possible to maintain a crown profile having a height δ1 substantially equal to that before increasing the temperature. When the thermal deformation suppressing film 13 is not used, as depicted by the broken-lined curve (c) in FIG. 2, both longitudinal ends of the slider body 11 expand more than the central portion. As a result, a crown profile is created having a height δ2 smaller than the height δ1 of the crown profile before increasing the temperature.

When ambient temperature of the magnetic head slider 1 decreases, the slider body 11 (including the protective film of the read/write element 10), the thermal expansion suppressing film 13, and the resin adhesive 14 are deformed in the same shrinking direction. In this case, since both longitudinal ends of the slider body 11 are in contact with the resin adhesive 14, the longitudinal ends shrink more than the central portion in the longitudinal direction by the thermal expansion of the resin adhesive 14. Since the thermal expansion coefficient of the thermal expansion suppressing film 13 is smaller than that of the slider body 11, the thermal expansion suppressing film 13 is operable to suppress the shrinking of the slider body 11 resulting from the decreased temperature. The medium-facing surface F is deformed in a direction that causes a central portion of the slider body 11 to protrude orthogonal to the longitudinal direction further away from the recording medium 11 by the difference in the thermal expansion coefficient of the thermal expansion suppressing film 13 and the slider body 11 (see the curve (b) in FIG. 3). Accordingly, the height of the central portion in the longitudinal direction of the slider body 11 decreases and thus balances out (cancels) the decreased height of both longitudinal ends resulting from the thermal shrinking of the resin adhesive 14. As a result, it is possible to maintain a crown profile having a height 51 substantially equal to that before decreasing the temperature. When the thermal deformation suppressing film 13 is not used, as depicted by the broken-lined curve (c) in FIG. 3, both longitudinal ends of the slider body 11 shrink more than the central portion. As a result, a crown profile is created having a height δ3 greater than the height 51 of the crown profile before decreasing the temperature.

In this way, when ambient temperature of the magnetic head slider 1 changes, the medium-facing surface F is automatically deformed in a direction that causes the central portion of the magnetic head slider 1 protrudes toward or away from the recording medium by the difference in the thermal expansion coefficient of the thermal expansion suppressing film 13 and the slider body 11. Accordingly, it is possible to suppress the change in the crown profile shapes resulting from the temperature difference.

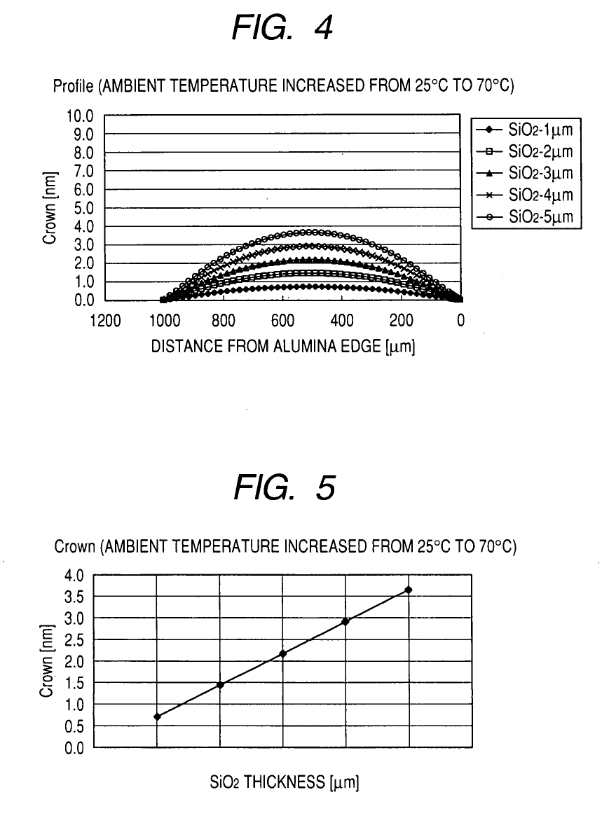

The amount of thermal deformation of the medium-facing surface F resulting from the temperature difference is determined by the size of the slider body 11 (length, width and thickness), the thickness of the thermal expansion suppressing film 13, and the difference in the thermal expansion coefficient between the layer 13 and the slider body 11. Assuming the same size of the slider body 11, the amount of thermal deformation of the medium-facing surface F resulting from the temperature difference increases as the thickness of the thermal expansion suppressing film 13 coated on the slider-bottom surface B also increases (see FIGS. 4 to 11). Also, the thermal deformation amount increases as the difference in the thermal expansion coefficient between the layer 13 and the slider body 11 also increases (see FIGS. 4 to 11).

Table 1 shows the thermal expansion coefficients of the protective film (Al₂O₃) exposed to the slider-bottom surface B, the slider body 11 (AlTiC), and the thermal deformation suppressing film 13 (SiO₂).

TABLE 1

| | Thermal Expansion Coefficient [K⁻¹] |
|---|---|
| Al₂O₃ | 7.1 × 10⁻⁶ |
| AlTiC | 7.1 × 10⁻⁶ |
| SiO₂ | 0.6 × 10⁻⁶ |

As can be seen from Table 1, the thermal expansion coefficient of the thermal expansion suppressing film 13 (SiO₂) is more than 10 times smaller than those of body 11 and the protective film of the read/write element 10. By controlling the thermal expansion coefficient of the thermal expansion suppressing film 13 so as to be more than 10 times smaller than that of the slider body 11, it is possible to decrease the thickness of the thermal expansion suppressing film 13 required to suppress the change in the crown profile shape. Even when the thermal expansion suppressing film 13 for suppressing the thermal deformation of the magnetic head slider 1 is as thin as 1 to 5 μm, the desired effect of suppressing the change in the crown profile shapes resulting from the temperature difference can be obtained.

Next, a fabrication method for the magnetic head slider 1 will be described.

First, a plurality of thin-film read/write elements is prepared on an AlTiC substrate. The substrate is cut for each read/write element to obtain a plurality of slider bodies 11. The slider bodies 11 may be sized to correspond to that of the pico slider or the femto slider.

Next, a crown processing is executed on the medium-facing surface F by performing a polishing processing onto the medium-facing surface F or the slider-bottom surface B of each of the slider bodies 11. The polishing process is a known method for the crown processing.

Subsequently, an arbitrary number of slider bodies 11 are selected from the plurality of the crown-processed slider bodies 11. Both longitudinal ends of each of the selected slider bodies 11 are bonded to the suspension 12 by means of the resin adhesive 14. Thus, magnetic head sliders for test are prepared. After preparing the magnetic head sliders for test, a change in the crown profile shapes is measured while varying ambient temperature of the sliders, for example increased from a room temperature to a high temperature, or decreased from a room temperature to a low temperature. Specifically, the amount of thermal deformation of both longitudinal ends of the medium-facing surface F is measured. In this embodiment, the room temperature, the high temperature, and the low temperature correspond to 25° C., 70° C., and 0° C., respectively. Then, based on the measurement result, the deformation amount of the central portion in the longitudinal direction of the slider body 11 and the thickness of the thermal deformation suppressing film are calculated that are required to balance out the thermal deformation amount of both longitudinal ends of the slider body 11.

For each of the crown-processed slider bodies 11, the slider-bottom surface B opposite the medium-facing surface F is coated with the thermal deformation suppressing film 13 and made of a material having a thermal expansion coefficient smaller than that of each slider body 11. In this case, the coating is individually performed to the crown-processed slider bodies 11. Also, the thickness of the thermal expansion suppressing film 13 is adjusted based on the thickness calculation.

After coating the thermal deformation suppressing film 13, the slider bodies 11 are bonded to the suspension 12. In this case, both longitudinal ends of each of the slider bodies 11 are bonded to the suspension 12 by means of the resin adhesive 14 with the thermal expansion suppressing film 13 disposed so as to face the suspension 12.

In this way, the magnetic head slider 1 shown in FIG. 1 is prepared.

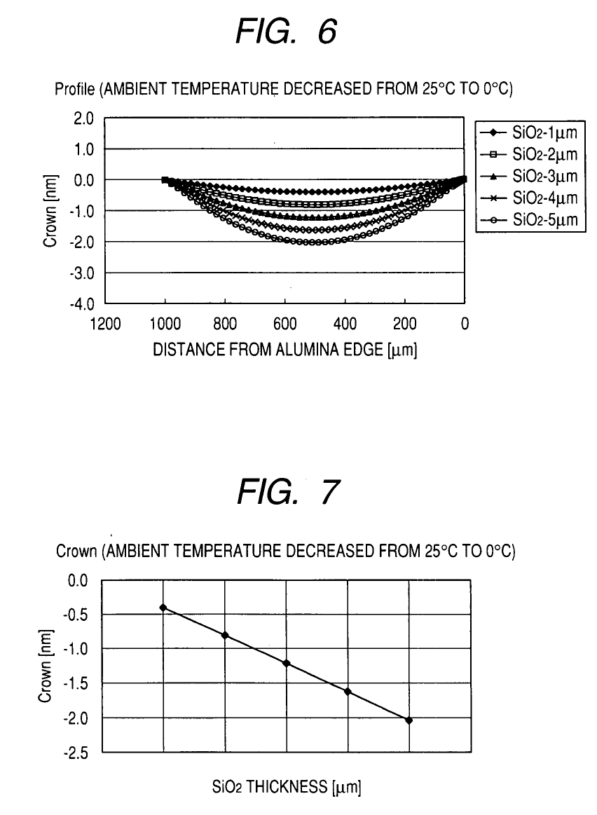

FIGS. 4 to 7 are graphs showing a relationship between the crown profile and the thermal deformation suppressing film 13 when the slider body 11 is the pico slider. FIG. 4 is a graph showing a change in profile shapes of the medium-facing surface observed at increased ambient temperature (from 25° C. to 70° C.), the change shown for each thickness (1 μm, 2 μm, 3 μm, 4 μm, 5 μm) of the thermal deformation suppressing film 13 used. FIG. 5 is a graph of a relationship between the amount of the change in crown profile shapes and the thickness of the thermal deformation suppressing film 13 used, the relationship observed at increased ambient temperature (from 25° C. to 70° C.). FIG. 6 is a graph showing a change in profile shapes of a medium-facing surface observed at decreased ambient temperature (from 25° C. to 0° C.), the change shown for each thickness (1 μm, 2 μm, 3 μm, 4 μm, 5 μm) of the thermal deformation suppressing film used. FIG. 7 is a graph of a relationship between an amount of the change in crown profile shapes and the thickness of the thermal deformation suppressing film 13 used, the relationship observed at decreased ambient temperature (from 25° C. to 0° C.). In the drawings, the amount of the crown profile shapes is measured based on the crown profile before varying the temperature.

As can be seen from FIGS. 4 and 5, when the ambient temperature increases, it can be confirmed that the central portion of the slider body 11 is deformed more than the longitudinal ends in a direction orthogonal to the longitudinal direction, e.g. where the central portion protrudes toward the recording medium. Also, it can be confirmed that the deformation amount of the central portion orthogonal to the longitudinal direction of the slider body 11 increases as the thickness of the thermal deformation suppressing film 13 used increases. Furthermore, it can be confirmed that the height of the crown profile increases as the thickness of the thermal deformation suppressing film 13 used increases. As can be seen from FIGS. 6 and 7, when the ambient temperature decreases, it can be confirmed that the central portion in the longitudinal direction of the slider body 11 is deformed more than the longitudinal ends in the direction where the central portion protrudes away from the recording medium. Also, it can be confirmed that the amount of deformation of the central portion of the slider body 11 orthogonal to the longitudinal direction increases as the thickness of the thermal deformation suppressing film 13 used increases. Furthermore, it can be confirmed that the height of the crown profile decreases as the thickness of the thermal deformation suppressing film 13 used increases.

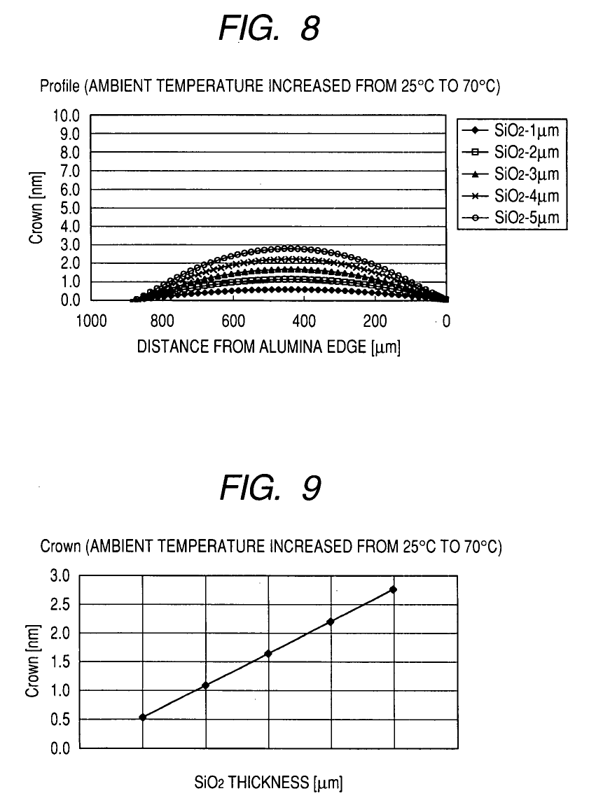

FIGS. 8 to 11 are graphs showing a relationship between the crown profile and the thermal deformation suppressing film 13 when the slider body 11 is the femto slider. FIG. 8 is a graph showing a change in profile shapes of the medium-facing surface observed at increased ambient temperature (from 25° C. to 70° C.), the change shown for each thickness (1 μm, 2 μm, 3 μm, 4 μm, 5 μm) of the thermal deformation suppressing film 13 used. FIG. 9 is a graph of a relationship between the amount of the change in crown profile shapes and the thickness of the thermal deformation suppressing film 13 used, the relationship observed at increased ambient temperature (from 25° C. to 70° C.).

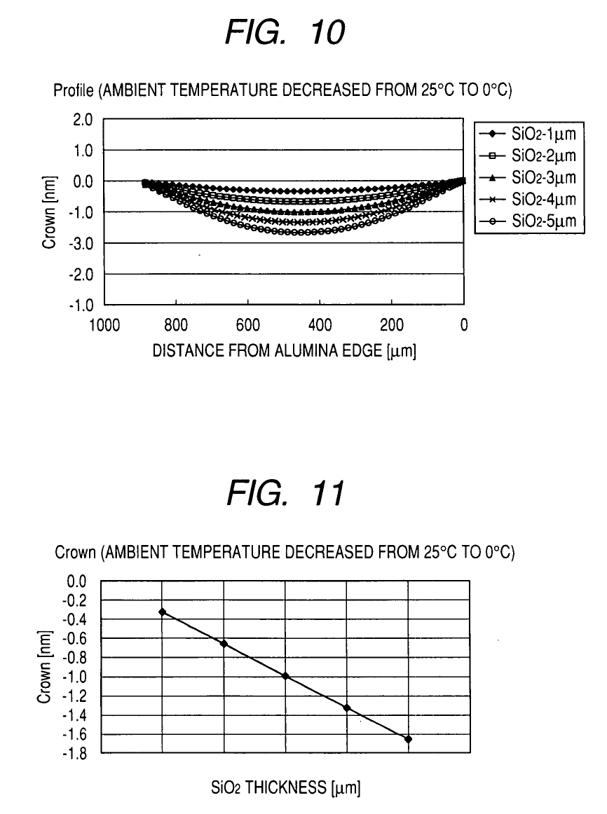

FIG. 10 is a graph showing a change in profile shapes of a medium-facing surface observed at decreased ambient temperature (from 25° C. to 0° C.), the change shown for each thickness (1 μm, 2 μm, 3 μm, 4 μm, 5 μm) of the thermal deformation suppressing film used. FIG. 11 is a graph of a relationship between an amount of the change in crown profile shapes and the thickness of the thermal deformation suppressing film 13 used, the relationship observed at decreased ambient temperature (from 25° C. to 0° C.). In the drawings, the amount of the crown profile shapes is measured based on the crown profile before varying the temperature.

As can be seen from FIGS. 8 and 9, when the ambient temperature increases, it can be confirmed that the central portion of the slider body 11 is deformed more than its longitudinal ends in a direction orthogonal to the longitudinal direction, e.g. where the central portion protrudes toward the recording medium. Also, it can be confirmed that an amount of deformation of the central portion orthogonal to the longitudinal direction of the slider body 11 increases as the thickness of the thermal deformation suppressing film 13 used increases. Furthermore, it can be confirmed that the height of the crown profile increases as the thickness of the thermal deformation suppressing film 13 used increases.

As can be seen from FIGS. 10 and 11, when the ambient temperature decreases, it can be confirmed that the central portion of the slider body 11 is deformed more than the longitudinal ends in a direction orthogonal to the longitudinal direction, e.g. where the central portion protrudes away from the recording medium. Also, it can be confirmed that the deformation amount of the central portion orthogonal to the longitudinal direction of the slider body 11 increases as the thickness of the thermal deformation suppressing film 13 used increases. Furthermore, it can be confirmed that the height of the crown profile decreases as the thickness of the thermal deformation suppressing film 13 used increases.

As is obvious when comparing the graphs shown in FIGS. 4 to 7 to the graphs shown in FIGS. 8 to 11, regardless of the type of the slider body 11 used (i.e., even the slider body 11 is the pico slider or the femto slider), the thermal deformation suppressing film 13 is operable to suppress the change in the crown profile shapes resulting from the temperature difference.

The terms and descriptions used herein are set forth by way of illustration only and are not meant as limitations. Those skilled in the art will recognize that many variations can be made to the details of the above-described embodiments without departing from the underlying principles of the disclosure. The scope of the disclosure should therefore be determined only by the following claims (and their equivalents) in which all terms are to be understood in their broadest reasonable sense unless otherwise indicated.

What is claimed is:

1. A magnetic head slider having a read/write element integrated on a slider body, in which a medium-facing surface of the slider body disposed to face a recording medium is subjected to crown processing, and both longitudinal ends of a slider-bottom surface disposed opposite to the medium-facing surface are bonded to a suspension by means of resin adhesive,
wherein the slider-bottom surface is entirely coated with a film having a thermal expansion coefficient smaller than that of the slider body so as to suppress thermal deformation.

2. The magnetic head slider of claim 1, wherein the thermal expansion coefficient of the thermal expansion suppressing film is more than 10 times smaller than that of the slider body.

3. The magnetic head slider of claim 1, wherein the slider body is made of AlTiC and the thermal expansion suppressing film is made of SiO₂.

4. A fabrication method for a magnetic head slider, the method comprising the steps of:
preparing a plurality of thin-film read/write elements on a substrate and cutting the substrate for each read/write element to obtain a plurality of slider bodies;
performing crown processing on medium-facing surfaces of the slider bodies;
coating surfaces disposed opposite the medium-facing surfaces with a film made of a material having a thermal expansion coefficient smaller than that of each slider body to suppress thermal deformation, the film being individually applied to the crown-processed slider bodies; and
bonding both longitudinal ends of each of the slider bodies to a suspension by means of resin adhesive with the thermal expansion suppressing film disposed to face the suspension.

5. The fabrication method of claim 4, wherein the thermal expansion suppressing film is made of a material having a thermal expansion coefficient more than 10 times smaller than that of the slider body.

6. The fabrication method of claim 4, wherein the substrate serving as the slider bodies is an AlTiC substrate and the thermal expansion suppressing film is made of SiO₂.

7. The fabrication method of claim 4, further comprising, after performing crown processing on the slider bodies, measuring a thermal deformation amount of the longitudinal ends of each of the slider bodies while varying ambient temperature of the magnetic head slider,
wherein a thickness of the thermal expansion suppressing film is adjusted based on the measurement result so that the thermal deformation amount of the longitudinal ends is balanced out by the adjusted film thickness.

8. The fabrication method of claim 4, further comprising, after performing crown processing on the slider bodies, measuring a thermal deformation amount of the longitudinal ends of each of the slider bodies while varying ambient temperature of the magnetic head slider,
wherein a type of the thermal expansion suppressing film is selected based on the measurement result, thereby adjusting a thermal expansion coefficient difference between the slider bodies and the thermal expansion suppressing film, wherein the thermal deformation amount of the longitudinal ends is substantially balanced out by the choice of the thermal expansion suppressing film.
